(19) United States
(12) Patent Application Publication
(10) Pub. No.: US 2002/0116625 A1
(43) Pub. Date: Aug. 22, 2002

(54) Method that causes program analysis of device driver to become difficult

(75) Inventor: Ryuji Sato, Tokyo (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: NEC CORPORATION

(21) Appl. No.: 10/076,404

(22) Filed: Feb. 19, 2002

(30) Foreign Application Priority Data
Feb. 20, 2001 (JP) 2001-043748

(51) Int. Cl. G06F 12/14

(52) U.S. Cl. 713/194

(57) ABSTRACT

Device driver 30 has initialization process 31, main process 32, and end process 33. A method for operating device driver 30 comprises a step of encrypting a program code portion of main process 32 of device driver 30, decrypting the program code portion in initialization process 31 of device driver 30, and re-encrypting the program code portion after it is executed and before device driver 30 is released.

### BACKGROUND OF THE INVENTION

1. Field of the Invention

The present invention relates to a device driver structuring method for preventing a third party from analyzing a device driver.

2. Description of the Prior Art

So far, technologies for preventing data and software from being forged (falsified) and illegally used have been proposed. Japanese Patent Laid-Open Publication No. 2000-122861 titled “System for preventing data and so forth from being illegally forged and encrypting apparatus used along therewith” discloses such a technology as a first prior art reference. In the first prior art reference, encrypted program code is divided into a plurality of blocks. To release encryption about a block that is executed next, an encryption key is calculated using a hash function or the like. Thus, when an illegal user forges a part of program code, a correct encryption key cannot be obtained. As a result, the execution of the program stops.

In addition, Japanese Patent Laid-Open Publication No. 2000-347848 titled “Semiconductor IC, information processing method, information processing apparatus, and program storing medium” discloses such a technology as a second prior art reference. In the second prior art reference, a content is encrypted and the encrypted content is recorded. In addition, an encryption key is also encrypted with a storage key and the encrypted encryption key is recorded. Thus, even if a content is copied, it cannot be decrypted. Thus, a large number of copies can be prevented from being distributed. When a personal computer supplies data to an external device, they are pre-authenticated with each other. Thus, data can be prevented from being supplied to an illegal external device. In addition, when data is supplied from an external device to a personal computer, it is determined whether or not software of the personal computer is legal by a mutual authentication. Thus, the external device can prevent data from being supplied to an illegal computer. The mutual authentication is performed through an authenticating station.

In addition, Japanese Patent Laid-Open Publication No. 2000-347852 titled “Information processing apparatus, information processing method, and program storing medium” discloses such a technology as a third prior art reference. In the third prior art reference, a predetermined portion of a software function of a personal computer is processed by an external adaptor. Thus, only when software of the personal computer is analyzed, it is difficult to know the overall process. As a result, it becomes difficult for an illegal user to forge (falsify) the software corresponding to his or her intention. In addition, the software program of the personal computer is encrypted with a program encryption key. Data necessary for executing the program is encrypted with a data encryption key created by the adaptor. Thus, even if only the program is obtained in the form of a CD-ROM or the like, the program cannot be executed by another adaptor.

In addition, Japanese Patent Laid-Open Publication No. 3-276345 titled “Micro controller” discloses such a technology as a fourth prior art reference. In the fourth prior art reference, a program or data that has been scrambled is stored to a memory. Key data for decrypting the scrambled program or data is stored to another memory.

In addition, Japanese Patent Laid-Open Publication No. 11-39158 titled “Method and apparatus for protecting executable program” discloses such a technology as a fifth prior art reference. In the fifth prior art reference, one LSI chip contains a ROM such as FROM (flash memory), a RAM, and a processing portion. In such an LSI, when the content of the RAM is copied, a secret key of a processing device cannot be prevented from being read. To solve such a problem, it is determined whether or not an executable program has been forged. When the executable program is forged, the execution of the program is immediately stopped. In reality, an edited message digest of an executable program and a second message digest of an encrypted executable program are collated with. When they do not match, it is determined that the executable program has been forged. In this example, the message digest is data of the last 16 bytes of which the executable program has been processed with a one directional hash function.

A device driver is a special program for controlling input and output of data between hardware and an OS (Operating System) corresponding to the specifications of the OS. A device driver can absorb the difference of specifications of manufacturers and use hardware in the same procedure. In a conventional OS, to allow hardware (such as a video card and a sound card) of same type of different manufacturers to be handled in common, a device driver is intermediated. A device driver is provided by a manufacturer, and hardware accessing methods from applications on the OS are standardized. At that point, a device driver absorbs the differences of input and output methods for devices. Thus, for example, it is not necessary for the application side to provide different programs corresponding to types of video cards. Since a device driver is a special program that directly handles hardware, the device driver is executed in a privileged level of which there are no restrictions of memory access and input and output instructions unlike with an application.

In recent years, from a viewpoint of copy prevention and copyright protection, data such as image data and voice data is often encrypted. The encrypted data is decrypted to original data by a reproducing application. Thereafter, the decrypted data is output to a device driver. Consequently, especially, device drivers for a video card and a sound card receive data of which encrypted music and audio data has been decrypted. Thus, when a malicious third party forges a device driver or traps a data input portion, decrypted data may be recorded to an external storing device. By comparing decrypted data with encrypted data, an encrypting algorithm may be analyzed or the key may be stolen.

To do that, the third party should know a procedure for accessing to the hardware. Since a device driver notifies hardware of data corresponding to a procedure, the device driver does not need an ornamental portion as an application. Thus, the structure of a device driver is simpler than the structure of such an application program.

Thus, when a third party reverse-engineers a device driver, he or she can easily obtain information of hardware such as access procedure.

### SUMMARY OF THE INVENTION

Therefore, an object of the present invention is to provide a device driver structuring method that causes a program analysis of a device driver to become difficult.

In order to attain the above object, according to a first aspect of the present invention, there is provided a method for operating a device driver which comprises encrypting a program code portion of a main process of a device driver; decrypting the encrypted program code portion in an initialization process of the device driver; and re-encrypting the decrypted program code portion after the decrypted program code portion is executed and before the device driver is released.

According to a second aspect of the present invention, there is provided a method for operating a device driver which comprises encrypting a program code portion of a main process of a device driver; initializing the device driver; decrypting the encrypted program code portion after the initialization process is performed; re-encrypting the decrypted program code portion after the decrypted program code portion is executed; and releasing the device driver after re-encrypting.

According to a third aspect of the present invention, there is provided a method for operating a device driver which comprises encrypting a program code portion of a main process of a device driver with a first encryption key and then encrypting the encrypted program code portion with a second encryption key; decrypting the program code portion that has been encrypted with the first encryption key with a first decryption key in an initialization process of the device driver; decrypting the program code portion that has been encrypted with the second encryption key with a second decryption key after the initialization process is completed; re-encrypting the program code portion with the second encryption key after the program code portion is executed; and re-encrypting the program code portion with the first encryption key after the program code portion is executed and before the device driver is released.

In a device driver operating method according to the present invention, a procedure portion and a program code portion of a main process of a device driver that are prevented from being analyzed are pre-encrypted. In an initialization routine, the encrypted portions are decrypted. Before the driver is released, the decrypted portions are re-encrypted. A key used in the decrypting process and the encrypting process may be obtained by a calculation performed several times using an area in common with the device driver and the application. This operation is based on a characteristic of the device driver that operates in the privilege mode that does not have a restriction of a memory access.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a schematic diagram of a conventional OS showing the relation among a device driver, hardware, and an application;

FIG. 2 is a schematic diagram showing that data is copied by a forged device driver;

FIG. 3 is a schematic diagram showing the structure of a conventional device driver;

FIG. 4 is a schematic diagram showing the structure of a device driver according to the present invention;

FIG. 5 is a flow chart showing an execution of a device driver;

FIG. 6 is a schematic diagram showing that decryption and re-encryption are executed in the main process; and

FIG. 7 is a schematic diagram showing that an application and a device driver mutually check whether or not they have been forged.

### DESCRIPTION OF PREFERRED EMBODIMENTS

Next, with reference to the accompanying drawings, embodiments of the present invention will be described.

### First Embodiment

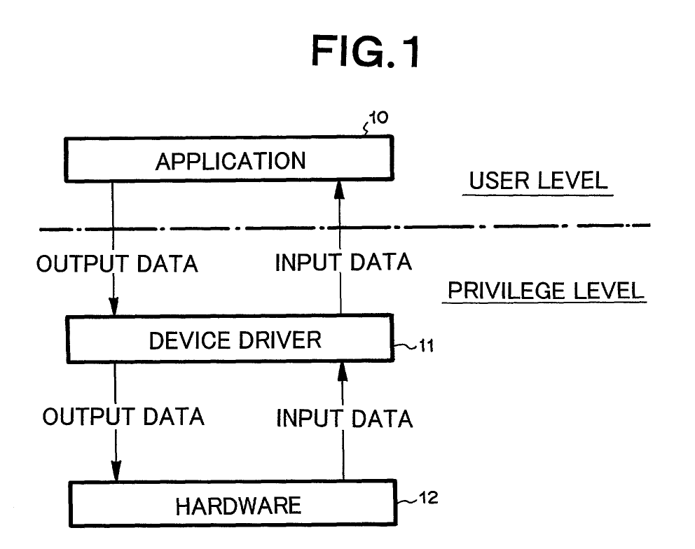

FIG. 1 is a schematic diagram showing the role of a device driver on a conventional OS. Data is supplied from application 10 in the user level to device driver 11. The device driver 11 outputs the supplied data to hardware 12 corresponding to a procedure that is unique to the manufacturer. When data is input, the device driver 11 supplies data received from the hardware 12 to the application 10 corresponding to the specifications of the OS. In contrast, when data is output, the device driver 11 outputs data received from the application 10 to the hardware 12 corresponding to the specifications of the hardware 12. The application 10 is a program in the user level that has a restriction of a memory access. Since the device driver 11 should directly exchange data with the hardware 12, the device driver 11 is assigned a privilege level. The privilege level is a authorization level of which there are no restrictions of a memory access and input and output to hardware.

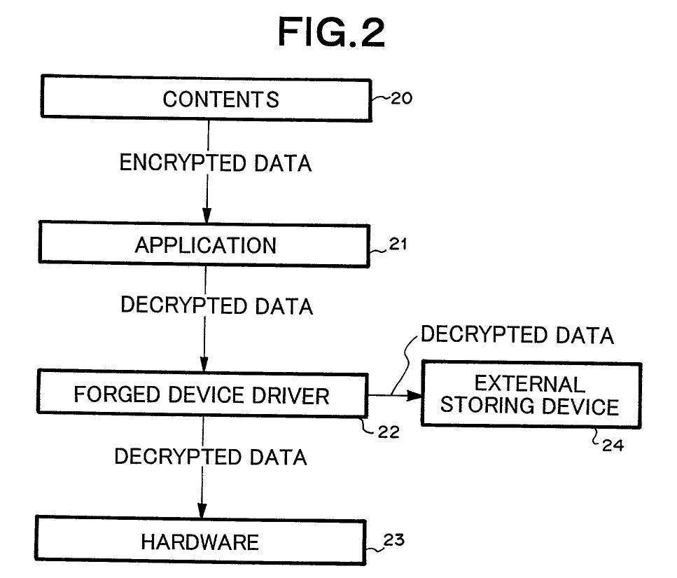

FIG. 2 is a schematic diagram for explaining the case that a device driver is forged by a third party. In this case, it is assumed that contents 20 that has been copyrighted is reproduced by application 21. In this case, encrypted data of the contents 20 is decrypted by the application 21 and supplied to hardware 23 through a device driver. At that point, since data that is supplied to the device driver has not been encrypted, when the third party uses forged device driver 22, he or she can store the non-encrypted data to external storing device 24.

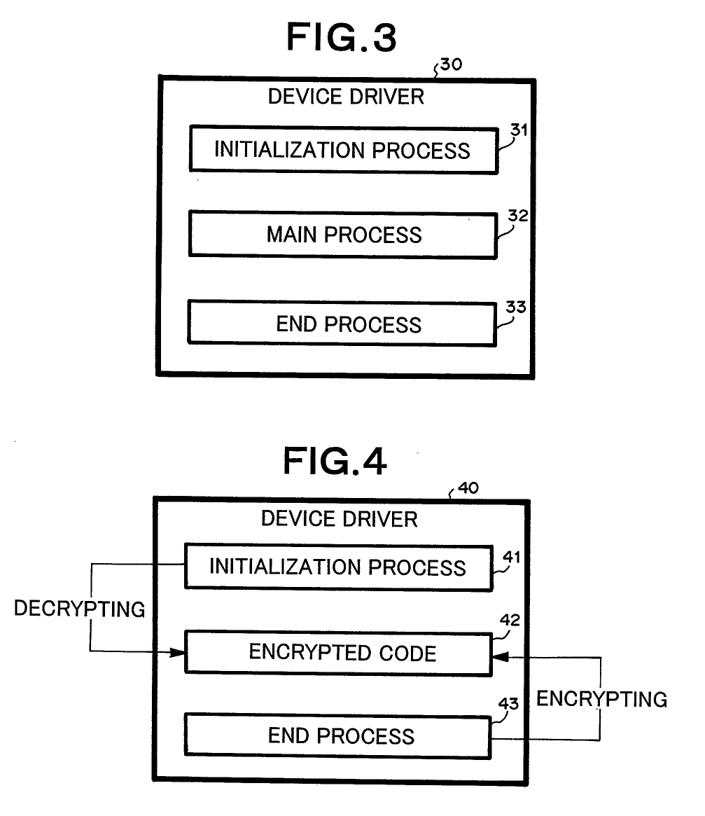

FIG. 3 shows the structure of a conventional device driver. Referring to FIG. 3, device driver 30 has initialization process 31, main process 32, and end process 33. The initialization process 31 is a process performed when the device driver is started. The main process 32 is an input and output process for data between the application and the device. The end process 33 is a process performed before the device driver is released. When the device is connected, the device driver 30 executes the initialization process 31. Thereafter, when the device is used, the device driver 30 performs the main process 32 for intermediating data. When the operation of the device is completed, the device driver 30 performs the end process 33 for releasing the device.

FIG. 4 shows a device driver that is protected according to the present invention. Since a program code portion that is equivalent to the main process 32 shown in FIG. 3 has been encrypted, a third party cannot analyze the device driver using a deassembler. In an initialization process 41, encrypted code 42 is decrypted. Thus, when the device is used, since the encrypted code 42 has been restored to original program code, a normal process can be performed for the encrypted code 42. When the device is released, in end process 43, the program code is restored to the encrypted code 42.

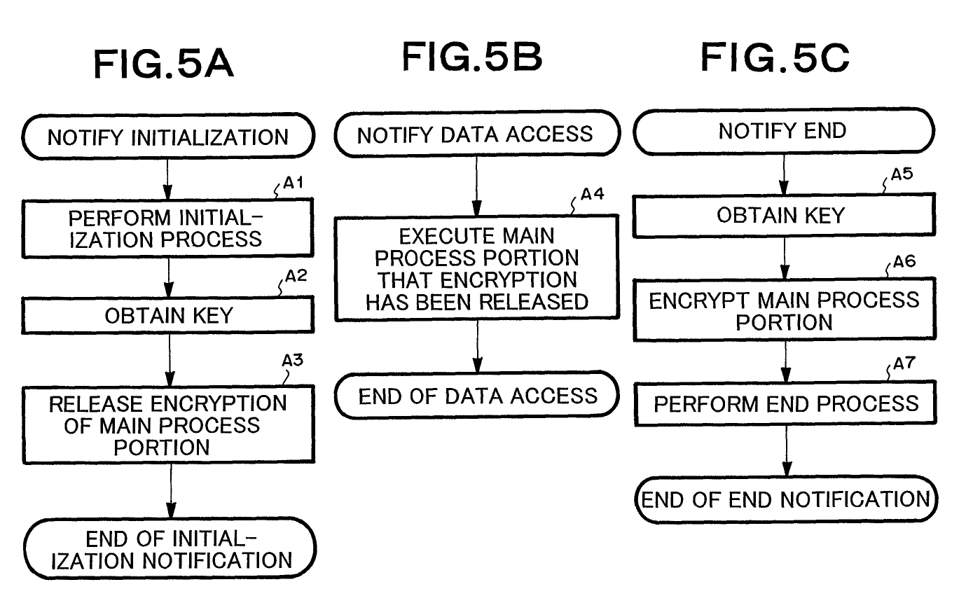

FIG. 5A is a flow chart for explaining the initialization process. In this example, it is assumed that a device driver is of event driving type.

The application requests the device driver to input and output data. The application receives a request for starting the device driver from the OS, the program of the device driver is loaded and an initialization event is issued. As a result, the initialization process is performed (at step Al).

Thereafter, a numeric value is extracted from a particular position of a memory of the application. The extracted numeric value is calculated. The calculated result is used as a decryption key (at step A2).

Thereafter, the encrypted code 42 is decrypted and restored to executable program code. Thereafter, the initialization process is completed (at step A3).

FIG. 5B is a flow chart for explaining a data access process. When the application requests the hardware to supply data, a data access notification event is issued. Since the encrypted code 42 has been decrypted that becomes code of the main process portion, the code is executed (at step A4).

A request for completing the operation of the device driver is received from the OS. Thereafter, an end process event is issued.

FIG. 5C is a flow chart for explaining the end process.

The device driver extracts a numeral value from a particular position of a memory of the application, performs a calculation for the extracted numeric value, and obtains a encryption key from the calculated result (at step A5).

Thereafter, the decrypted program code of the main process portion is re-encrypted (at step A6).

Thereafter, an end process necessary for completing the operation of the device driver is performed (at step A7).

When the end process is performed, it is necessary to re-encrypt the main process portion. Because even if the device driver is released, the program code of the device driver remains in the memory. To prevent the code that remains in the memory from being analyzed, when the end process is performed, the main process portion is re-encrypted.

Next, the method for obtaining a key from a memory of the application performed at steps A2 and A5 will be described.

When the initialization process is performed, the application notifies the device driver of an area used for creating a key. Since the device driver is assigned the privilege mode, optional memory area of the application can be accessed. An initial value has been set to the area for creating the key. A predetermined calculation is performed for the initial value several times. The resultant numeric value is used as a key.

### Second Embodiment

Release of the encryption (decryption) is executed just before the main process is executed and re-encryption is executed just after the main process is executed. As a result, although the execution speed becomes slow, the time period for which the release of the encryption is kept becomes very short. Consequently, a device driver that is prevented from being analyzed can be structured.

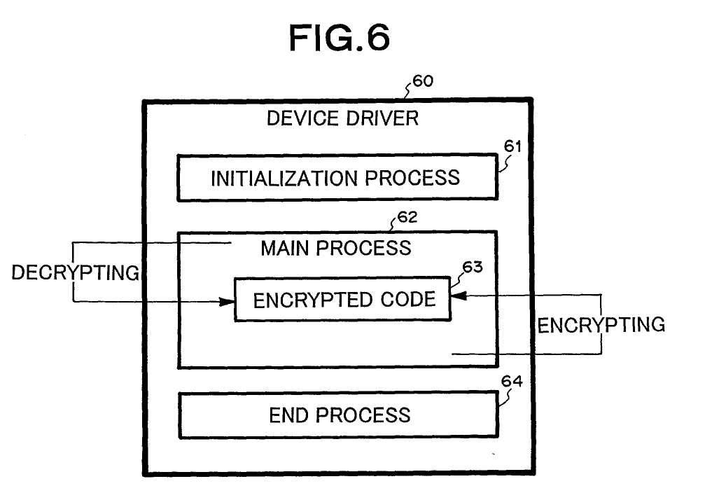

In FIG. 6, device driver 60 has initialization process 61, main process 62, and end process 64. In the main process 62, only a process portion to be really protected is encrypted as encrypted code 63. When the main process is performed, the encrypted code 63 is decrypted and executed. Thereafter, the encrypted code 63 that has been decrypted is re-encrypted. Unlike with the first embodiment, the decryption is not executed in the initialization process 61. The re-encryption is not executed in the end process 64. Since the decryption and the re-encryption are executed in the main process, whenever the main process is executed, the decryption and the re-encryption are executed. Thus, although the process speed becomes slow, since the process portion to be protected is decrypted for a very short time period, it become very difficult to analyze the process portion.

### Third Embodiment

In this embodiment, a method for operating device driver comprises encrypting a program code portion of a main process of a device driver with a first encryption key and then encrypting the encrypted program code portion with a second encryption key; decrypting the program code portion that has been encrypted with the first encryption key with a first decryption key in an initialization process of the device driver; decrypting the program code portion that has been encrypted with the second encryption key with a second decryption key after the initialization process is completed; re-encrypting the program code portion with the second encryption key after the program code portion is executed; and re-encrypting the program code portion with the first encryption key after the program code portion is executed and before the device driver is released.

In an initialization process, encrypted code is decrypted. After the initialization process, the decrypted code is re-encrypted. Just before a main process is executed, the re-encrypted code is re-decrypted. After the main process, the re-decrypted code is encrypted again. As a result, since code is encrypted on two stages, a device driver that has a strong resistance against an illegal analysis can be structured. At that point, the encrypting process on the second stage focuses on the process speed rather than the resistance against the analysis, whereas the encrypting process on the first stage focuses on the resistance against the analysis rather than the process speed. As a result, a system having a strong resistance against an illegal analysis, for example, a deassembler can be structured.

### Fourth Embodiment

A plurality of areas used for creating a key are disposed on the application side. Calculation is performed for each of the plurality of areas. Among them, only one is used as a key corresponding to a predetermined rule. The other areas are used as dummy areas that cause a third party to get confused.

### Fifth Embodiment

An authentication may be performed between an application and a device driver. By utilizing the area being used between the application side and the device driver as an area for creating a key, an authentication can be performed. Thus, the device driver can always check that data is exchanged with a particular application.

### Sixth Embodiment

Detection of forging is executed between an application and a device driver in this embodiment

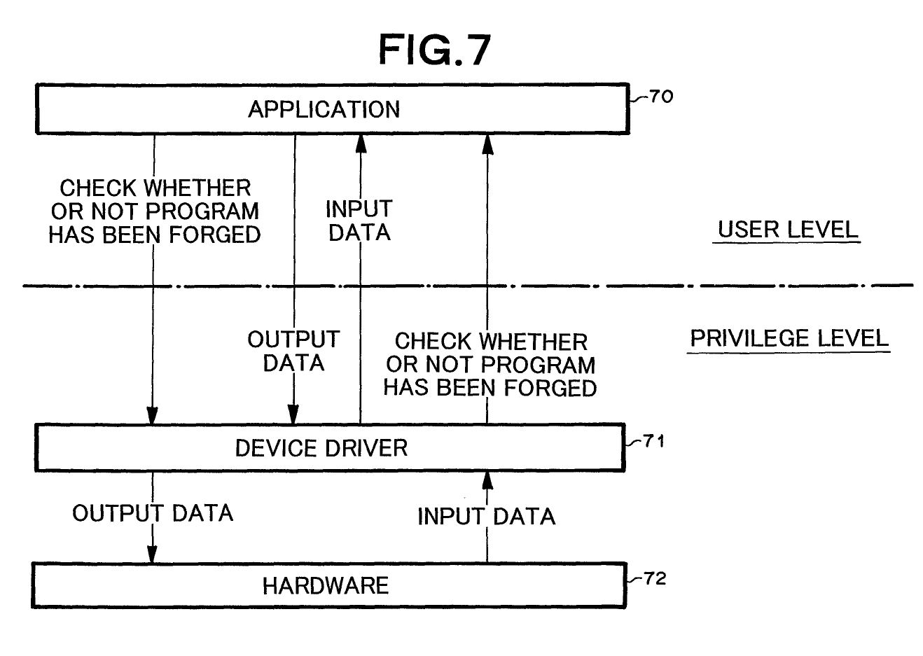

As shown in FIG. 7, the application and the device driver detect at each other whether or not they have been forged. Before application 70 outputs data of contents to device driver 71, the application 70 checks whether or not program code of the device driver 71 has been forged. When the program code has been forged, the application 70 stops outputting data to hardware 72. Before the device driver 71 supplies data to the application 70, the device driver 71 checks whether or not a program of the application 70 has been forged. When the program of the application 70 has been forged, the device driver 71 stops inputting to the application 70 data from the hardware 72. To check whether the program has been forged, it is preferred to use a hash value of which a value of program code is input. Thus, after checking that the application and the device driver have not been forged, they can output data.

### Seventh Embodiment

A device driver does not decrypt all data and a part or all of data of the contents is kept an encrypting state. Only when encrypted data of the content has not been forged, an application decrypts the encrypted data and outputs the decrypted data to the device driver. As a result, even if the access method to hardware is analyzed and thereby an illegal device driver is created, unless the decrypting method of the data is obtained, it is difficult for a third person to obtain the data.

As described above, according to the present invention, a device driver can be prevented from being analyzed and forged by a third party. This is because a program of a data access portion has been encrypted. When the device driver is started, the program is decrypted. After the operation of the device driver is completed, the program is re-encrypted. As a result, the device driver is prevented from being analyzed. With an area on the application side, a calculation is performed by the device driver and application so as to obtain a key for decrypting and encrypting the program. Since the device driver is assigned a privilege mode, the device driver can read and write data to and from any area of the application side. Thus, since the key for decrypting the program can be dispersed, it can be prevented from being analyzed.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is

1. A method for operating a device driver, comprising the steps of:
encrypting a program code portion of a main process of a device driver;
decrypting the encrypted program code portion in an initialization process of said device driver; and
re-encrypting the decrypted program code portion after the decrypted program code portion is executed and before said device driver is released.

2. A method for operating a device driver, comprising the steps of:
encrypting a program code portion of a main process of a device driver;
initializing said device driver;
decrypting the encrypted program code portion after the initialization process is performed;
re-encrypting the decrypted program code portion after the decrypted program code portion is executed; and
releasing said device driver after re-encrypting.

3. A method for operating a device driver, comprising the steps of:
encrypting a program code portion of a main process of a device driver with a first encryption key and then encrypting the encrypted program code portion with a second encryption key;
decrypting the program code portion that has been encrypted with the first encryption key with a first decryption key in an initialization process of the device driver;
decrypting the program code portion that has been encrypted with the second encryption key with a second decryption key after the initialization process is completed;
re-encrypting the program code portion with the second encryption key after the program code portion is executed; and
re-encrypting the program code portion with the first encryption key after the program code portion is executed and before said device driver is released.

4. The method as claimed in claim 1, wherein at least one memory area is disposed on an application and a key for encrypting and decrypting the program code portion in said encrypting, decrypting and re-encrypting steps is created corresponding to a numeric value stored in one of the memory areas.

5. The method as claimed in claim 2, wherein at least one memory area is disposed on an application and a key for encrypting and decrypting the program code portion in said encrypting, decrypting and re-encrypting steps is created corresponding to a numeric value stored in one of the memory areas.

6. The method as claimed in claim 1, wherein an authentication is performed between an application and said device driver.

7. The method as claimed in claim 2, wherein an authentication is performed between an application and said device driver.

8. The method as claimed in claim 1,
wherein before supplying output data to said device driver, an application detects whether or not the program code portion of said device driver has been forged and when the program code portion has been forged, the application stops outputting the output data to hardware, and
wherein before supplying input data to the application, said device driver detects whether or not the program code portion of the application has been forged and when the program code portion has been forged, said device driver stops outputting the input data to the application.

9. The method as claimed in claim 2,
wherein before supplying output data to said device driver, an application detects whether or not the program code portion of said device driver has been forged and when the program code portion has been forged, the application stops outputting the output data to hardware, and
wherein before supplying input data to the application, said device driver detects whether or not the program code portion of the application has been forged and when the program code portion has been forged, said device driver stops outputting the input data to the application.

10. The method as claimed in claim 8,
wherein said device driver does not decrypt the encrypted data of the application, and
wherein only when the program code portion has not been forged, the application decrypts the encrypted data and outputs the decrypted data to said device driver.

11. The method as claimed in claim 9,
wherein said device driver does not decrypt the encrypted data of the application, and
wherein only when the program code portion has not been forged, the application decrypts the encrypted data and outputs the decrypted data to said device driver.
